(19) United States
(12) Patent Application Publication
(10) Pub. No.: US 2004/0043200 A1
(43) Pub. Date: Mar. 4, 2004

(54) Pliable paper

(76) Inventor: Jan K. Masek, Los Angeles, CA (US)

Correspondence Address: JAN MASEK, 302 North La Brea Avenue # 1000, Los Angeles, CA, 90036, US

(21) Appl. No.: 10/229,433

(22) Filed: Aug. 28, 2002

(51) Int. Cl. B32B 3/00

(52) U.S. Cl. 428/195.1

(57) ABSTRACT

A pliable paper sheet capable of being thick and comprising natural hardwood and softwood fibers wherein either hardwood or softwood fibers do not comprise more than 60% of hardwood or softwood fibers by weight in the paper, and at least 2% liquid latex additive by weight, said latex having a transition glass temperature lower than room temperature.

### DISCUSSION OF RELATED ART

Modern imaging and paper handling machines such as photocopiers, laser printers, and ink jet printers have very challenging paper paths. To maximize office space, machines are made with a small footprint, which is the floor or desk space a printer occupies. Thus, a paper path can be very short with sharp curves inside the machine. These sharp curves and angles can very easily make many types of paper sheets jam.

For that reason, office equipment manufacturers provide paper specifications that require certain paper properties such as thickness, stiffness, weight, and surface smoothness. This restriction usually excludes the use of thick media on regular office machines. Thick paper printing is usually outsourced to commercial printers who have large heavy duty printing machines. Thus, there is a sharp contrast between the abilities of heavy duty printing capable at commercial printers and the regular office printers that most office workers are familiar with.

Office printer specifications usually generalize that paper thickness is directly proportional to rigidity. On the contrary, a paper could be 20 thousandths of an inch thick but also very stiff. Most office printers can print on paper up to 24 Lb bond and perhaps 28 Lb bond but few accept papers higher than 28 Lb. 28 Lb is not that thick in the commercial paper industry, yet office needs regularly exceed 28 Lb. Sometimes a sheet is termed in the commercial printing industry as “one thick ply” or “two thick plys”. Commercial printing sometimes requires feeding thick sheets. When feeding the equivalent of two 28 Lb pieces the product is folded onto itself making it far thicker than most office printers specify. To date there is not paper that is 40 thousandths of an inch thick and more pliable and flexible than a thinner sheet. The following is a discussion of paper thickness.

A standard photocopy sheet is 3.8 thousands of an inch thick and is usually referred to as a 20 Lb sheet. A check stock is 4.5 thousands of an inch thick and is called a 24 Lb sheet. A # 10 envelope is usually 24 Lb as well.

Still thicker are 9×12 and 10×13 envelopes which are 5.2 thousands of an inch or 28 lbs. Postcard inserts in a magazine are usually 7 thousands of an inch or 7 Point or 36 lb equivalent. If one inch=1000 thousandths, then a 36 lb. sheet, would be 1000 divided by 7 which is 142 sheets per inch thickness. A photocopy sheet at 3.8 thousands requires 263 sheets per inch. Thus, a ream of 500 sheets of photocopy paper is about 2 inches thick.

Paper is a little confusing because the “weight” number applies only by class of papers. For example a 60 Lb Book grade paper is different in thickness than a 60 Lb Index. Index papers are a different class than Book papers. Thus, the # of Lbs depends upon the class of paper being referred to.

Another example: photocopy paper from a class of papers called BOND usually weighs 20 Lb. A glossy paper booklet would be printed on a 60 Lb-coated BOOK sheet. This does not mean that the BOOK class paper is 3 times thicker. (20 lb Vs 60 lb) The scale and numbers change with each class of paper. For example, a photocopy BOND sheet is 20 Lb when 500 sheets of “X” inches by “Y” inches weigh 20 Lb. But the BOOK sheet is 60 LB when 500 sheets of “V” inches by “W” inches weighs 60 lb.

Paper is usually made of natural fibers of cellulose extracted usually from wood. But it could be made of 100% cotton, hemp, or rice. It does not have to be 100% natural or just wood. However it's mostly wood. Wood fibers come in two types, SOFT WOODS=long fibers that lend strength to papers (they tend to be 3× longer and 2× as thick as hardwood fibers) and HARD WOODS=short fibers and make for a weaker sheet. The hardwood, softwood blend are preferably approximately equal in weight in a range between 40% to 60% hardwood, softwood and 60% to 40% hardwood, softwood. Office paper is usually made on a “paper machine” that can be longer than a football field and cost hundreds of millions of dollars. Paper is made by mixing fibers (could be short or long OR a percentage of each depending on the type of paper to be made. Then water and chemicals are added to impart different properties to the paper. Gradually this liquid soup is spilled on a moving mesh screen and water is taken out by gravity and heating. Moving along the machine, it gradually becomes more dry then wet and at that point becomes more like a tissue product such as paper napkins, toilet or kitchen tissue paper. Then if it is to become a “business” paper, “ash” or “sizing” is added to fill in between the fibers and pressure and heated rollers press all of this into a sheet which no longer looks like a tissue but something you can write on. Examples of fillers are clay, titanium and calcium carbonate. The part about the pressing of the sheet is called calendaring. The more calendaring. the smoother the sheet. For example, paper called laser papers are very smooth because toner sticks much better to paper if very smooth. Paper which is not smooth impairs the ability of the toner to anchor on the sheet and it can easily flake off.

So how much fiber is used, what kinds of fibers, how much chemicals and fillers are used and how much calendaring is done dictates how thin or thick, rough or smooth, stiff or pliable, light or heavy a sheet will be.

A standard test in the paper industry for stiffness is called the TABER stiffness test. There is also another stiffness test called GURLEY. Another type of measurement is called a paper's “hand” which is a way to measure pliability in a different way. Industry experts caution that the “hand” measurement and the actual feel of the paper do not always correlate real well.

Paper has a “grain”. That means the direction of the fibers. Most fibers go in the same direction and align themselves. That's because as it gets dried, this soup is gently moved left to right and this causes most of the fibers to line up in one direction. This is the grain. And the grain is with the direction of the web of paper being made. If you have tried to tear a piece of newspaper, usually top to bottom you can tear it fairly clean. Then when you go in the other direction, left to right, it tears but very badly. So top to bottom is “with the grain” (how the soup was flowing down the paper machine) and left to right is “against the grain” and that would be across the web while the web is being formed. For example if you took toilet paper and tried to split the roll in two, to some extent it would kind of behave ok. But if you tried to split the toilet paper in two in the other direction and not do it where it is already perforated, it would tear but out of control because you are trying to tear across the grain.

Even some continuous computer printers such as “band” or “impact” or “dot matrix” who are fed with thick multi ply continuous forms such as medical statements and tax forms often jam because standard paper is not sufficiently malleable/pliable. This stiffness in regular sheets is the source of much office downtime, manufacturing losses and rejects.

Envelopes are made of folded paper and as a 2 to 3 thickness type product (due to the many seams where the various panels fold and glue to each other) can be difficult to feed in such printers

Papers with enough desired strength may be either or both too thick or too stiff to perform properly and therefore jam and cost staff downtime OR damage equipment.

Pliability is a common term. In the paper industry paper is said to have “soft hand” or “drape” to express flexibility. When using the word “hand” it should be with soft because sometimes, hand alone could mean a stiff paper.

The weight of stocks (how much 500 sheets weigh for a specific size per class of paper) fed can go well beyond the “recommended” weight if the paper has a special formulation and method of manufacturing. This is also true of the caliper (the actual thickness of a sheet in thousands of an inch). The paper fed may be a medium or thick sheet that will have pliability rendering it able to navigate the paper path of most modern imaging equipment.

Eastman Kodak Patent 6,004,732 discusses controlling bending stiffness in photographic paper. Bending stiffness is one factor among many that determines the usefulness of paper. Erik Dam U.S. Pat. No. 4,619,858 discloses an adhesive paper material with a label made from poly layer material. A pressure sensitive label product allows the use of a poly layer lamination that allows fairly strong and thin paper.

Thomas C. Naber U.S. Pat. No. 5,318,825 discloses paper having concealed repositionable adhesive. This patent uses adhesive to maintain a fold during printing later exposed for adhesion of the paper.

### OBJECTS OF THE INVENTION

1. It is a goal of the invention to use an adhesive to retain multiple layers of a paper sheet while the paper is fed through an office machine such as a copier.

2. It is also a goal of the invention to use certain ingredients to make paper pliable and flexible, even if the paper is comprised of a laminate having 2 or 3 layers.

### FIELD OF THE INVENTION

The invention comprises a thick sheet of paper which being thicker than 24 lb would have difficulty in passing through conventional office machines. Such paper may be thick due to it being comprised of multiple layers either due to it being folded or due to separate sheets bonded by an adhesive. The thick paper can also be a folded sheet having a permanent adhesive such as envelope glue or a non-permanent adhesive. The original sheet can be unfolded after printing on a printer. The paper could also be more than one sheet of paper held either with permanent or non permanent or even of both types of adhesives on the same sheet as per the Thomas C. Naber U.S. Pat. No. 5,318,825. In any case, the thick paper controls caliper independently from stiffness.

Many printers jam when a thick rigid sheet is introduced into the paper path. The ability to print on multiple sheet thick paper such as the composite laminates above allow a substantial technical advantage.

To soften the paper latex can be added when the paper is on the paper machine. When added on the machine, latex is added at the “size press” towards the end of the paper making process. The paper receives the final latex ingredients before being fully dried and fully calendared.

Although not preferable, the latex can be added later, in what the industry calls an ‘offline’ process. ‘Offline’ means the paper is finished. The finished paper is mounted on rollers and fed through a pool of liquid. A latex additive is added to the pool and the latex is rolled on the paper after a knife tool scrapes any excess. After drying well the paper is rewound into a roll.

The latex should be added while the sheet is in the paper machine and not dry yet. Here the latex can penetrate the sheet very well and cause the paper to become very pliable and also very strong. When the latex is added in the paper machine, the industry term is an ‘impregnated process’. The latex added has a Glass Transition Temperature (having a symbol Tg) below normal room temperature in order to assure a pliable sheet. The preferred range would be from 0 TO 16° C.

Additives

Latex has many substitutes and equivalents. Natural polymers or synthetic polymers can be used such as latex rubber. Typical business papers have near “0” polymers or latex added. Polymers can bring many properties to a sheet, besides pliability. They tend to increase translucence, a measurement of how much light can be seen thru the sheet or not. Titanium can be used as filler to add opacity. It can contribute to smoothness by filling gaps between paper fibers Types of synthetic polymers (latex) that could be used for a pliable sheet could be: Styrene Butadiene (SBR) between S=45% B=55% and S=40% B=60%. The following FOUR monomers: ethyl acrylate, butyl acrylate, ethyl aceitate AND ETHYLENE can be added to a styrene compound to create a proper compound. Styrene is not used in high proportion to latex.

Fillers are also used in paper. Carbonate fillers are preferred with latex as clay fillers may stiffen paper. Carbonate fillers also produce micro roughness to promote toner adhesion. When latex is used as a binder, too much pigment or filler such as calcium carbonate, clay, and titanium make the sheet stiffer.

Rheology modifiers are added to the latex solution to control flow and penetration of coating. They are used in amounts of less than 1% by weight. They promote viscosity in water, which holds a compound to promote sheet penetration. A charged metallic pigment cataionic or anaionic is sometimes added to restore proper electrical performance.

1. A pliable paper sheet comprising:
a. Natural hardwood and softwood fibers wherein either hardwood or softwood fibers do not comprise more than 60% of hardwood or softwood fibers by weight in the paper, and
b. At least 2% liquid latex additive by weight, said latex having a transition glass temperature lower than room temperature.

2. The pliable paper sheet of claim 1 wherein said liquid latex additive is a styrene butadiene or other polymer suspended in liquid.

3. The pliable paper sheet of claim 1 wherein said liquid latex additive has a glass transition temperature between 0-16 degrees Celsius.

4. The pliable paper sheet of claim 1 wherein said liquid latex additive is a mixture of a styrene compound and any one of the following three monomers: ethyl acrylate, butyl acrylate, ethyl aceitate.

5. The paper of claim 1 wherein said paper sheet is cut to a single ply paper.

6. The paper of claim 1 wherein said paper sheet is formed into multiple ply paper.

7. The paper of claim 1 wherein said paper sheet is folded.

8. A pliable paper sheet comprising:
a. Natural fibers, and
b. At least 2% liquid latex additive by weight, said latex having a transition glass temperature lower than room temperature.

9. The pliable paper sheet of claim 1 wherein said liquid latex additive is a styrene butadiene suspended in liquid.

10. The pliable paper sheet of claim 1 wherein said liquid latex additive has a glass transition temperature between 0-16 degrees Celsius.

11. The pliable paper sheet of claim 1 wherein said liquid latex additive is a mixture of a styrene compound and any one of the following three monomers: ethyl acrylate, butyl acrylate, ethyl aceitate.

12. The paper of claim 1 wherein said paper sheet is cut to a single ply paper.

13. The paper of claim 1 wherein said paper sheet is formed into multiple ply paper.

14. The paper of claim 1 wherein said paper sheet is folded.

15. A method of making a pliable paper sheet comprising the steps of:
a. Forming paper on a paper machine,
b. Adding a liquid latex binder at the size press before final drying of the paper,
c. Adding a rheology modifier to promote latex binder impregnation into paper.

16. The pliable paper sheet of claim 15 wherein said liquid latex additive is a styrene butadiene suspended in liquid.

17. The pliable paper sheet of claim 15 wherein said liquid latex additive has a glass transition temperature between 0-16 degrees Celsius.

18. The pliable paper sheet of claim 15 wherein said liquid latex additive is a mixture of a styrene compound and any one of the following three monomers: ethyl acrylate, butyl acrylate, ethyl aceitate.

19. The paper of claim 15 wherein said paper sheet is formed into multiple ply paper.

20. The paper of claim 15 wherein said paper sheet is folded.
